(19) United States
(12) Patent Application Publication
(10) Pub. No.: US 2015/0201209 A1
(43) Pub. Date: Jul. 16, 2015

(54) MOTION VECTOR DETECTION APPARATUS AND METHOD

(71) Applicant: Canon Kabushiki Kaisha, Tokyo (JP)

(72) Inventor: Daisuke SAKAMOTO, Tokyo (JP)

(21) Appl. No.: 14/598,995

(22) Filed: Jan. 16, 2015

Related U.S. Application Data
(63) Continuation of application No. 11/142,287, filed on Jun. 2, 2005.

(30) Foreign Application Priority Data
Jun. 11, 2004 (JP) 2004-174604

(51) Int. Cl. H04N 19/52; H04N 19/176

(52) U.S. Cl. CPC H04N 19/52; H04N 19/176

(57) ABSTRACT

When detecting a motion vector, the present invention sets a search window not on a current macro block but in a reference image, by obtaining a global vector expressing the motion between a current image and a reference image and using that global vector to set the search window in the reference image, thus enabling detection of a motion vector even in images with much motion.

### CROSS REFERENCE TO RELATED APPLICATIONS

The present application is a continuation of U.S. patent application Ser. No. 11/142,287, filed Jun. 2, 2005. The entire disclosure of the earlier application is hereby incorporated by reference herein.

### FIELD OF THE INVENTION

The present invention relates to a motion vector detection apparatus and method, and more particularly, to a motion vector detection apparatus and method that can adaptively detect a motion vector even where there is much motion between images.

### BACKGROUND OF THE INVENTION

In recent years, with the rapid digitization of information relating to so-called multimedia such as audio signals and video signals, video signal compression-encoding/decoding technologies have attracted attention. Compression-encoding/decoding technologies enable the memory capacity needed to store the video signals and the bandwidth needed for signal transmission to be reduced, and are thus extremely important to the multimedia industry.

These compression-encoding/decoding technologies compress the information size/data size using the highly-autocorrelated nature (that is, the redundancy) of most video signals. The redundancy that video signals have consists of temporal redundancy and two-dimensional spatial redundancy. The temporal redundancy can be reduced using motion estimation and motion compensation in block units. At the same time, spatial redundancy can be reduced using discrete cosine transform (DCT).

Using these techniques, MPEG and other methods known as compression-encoding/decoding technologies reduce the redundancy of the video signal and thus improve the data compression effect for the video frames/fields that change temporally. The block unit motion estimation for reducing temporal redundancy is an operation that picks out the most similar block between reference frame/fields continuously input (that is, a past frame/field) and a current frame/field, and the vector that expresses the direction and the extent of movement is called a motion vector. Therefore, motion estimation is the same as motion vector estimation.

In general, as a method of estimating a motion vector, a block matching method is used. The block matching method is a method that compares, in block units, two images, such as a reference frame/field and the current frame/field, and estimates motion, in block units, on the basis of their similarity. According to the block matching method, the motion vector is estimated block by block from the reference frame/field and the current frame/field, and motion-compensated prediction is performed using the estimated motion vector. The block matching method is described, for example, in Japanese Laid-Open Patent Publication No. 04-323780 (page 2), but a description of it is given here using FIG. 2.

FIG. 2 is a block diagram showing the motion vector detection apparatus used in the block matching method. In the diagram, the motion vector detection apparatus is composed of a current frame/field storage unit 20, a reference frame/field storage unit 21, a current macro block storage buffer 22, a reference search window storage buffer 23 and a motion vector search unit 24.

The current frame/field storage unit 20 and the reference frame/field storage unit 21 store the current frame/field and the reference frame/field, respectively, and are used to estimate the motion vector. The current macro block storage buffer 22 picks out the current macro block image from the current frame/field storage unit 20. The reference search window storage buffer 23 sets the center of a search area at the center of the current macro block and picks out a portion of an image from the reference frame/field storage unit 21 corresponding to the range of the search area (hereinafter called the search window). At the motion vector search unit 24, the current macro block image inside the search window is searched and the final motion vector for the current macro block is estimated.

In addition, in the block matching method, as shown in FIG. 3, the motion vector detection apparatus shown in FIG. 2 can also be given a motion vector storage device 35 that stores the motion vector estimated by the motion vector search unit 24. With this configuration, the motion vector estimated for the preceding macro block is provided to the reference frame/field storage unit 21 from the motion vector storage unit 35. The reference frame/field storage unit 21 then sets the center of the search area at a position offset from the current macro block by an amount equal to the motion vector for the preceding macro block, and outputs to the reference search window storage buffer 23.

Insofar as they conduct localized detection, all methods that conduct detection/estimation of motion vectors macro block by macro block and perform motion-compensated estimation using those motion vectors, as the block matching method does, are hereinafter together called local motion compensation methods. In addition, the block unit motion vectors are called local motion vectors.

The local motion compensation methods described above are used in current ISO systems H.261, H.263, MPEG1, MPEG2 and MPEG4, and are the most widely used motion compensation systems.

However, because local motion compensation systems use a search window composed of a number of pixels that is smaller than one frame, if the center of the search area is set at the center of the current macro block or the center of the search window is positioned using the motion vector of the previous macro block, then the macro block of a whole faning image or an image in which the motion between frames is fast, as with a baseball broadcast, will cease to exist within the search window. In such cases, in the conventional local motion compensation systems, an image encoder does not perform a non-intra- (or inter-) coding operation that obtains a difference value between images is not performed and intracoding is performed instead, which results in a reduction in the compression rate and an increase in the size of the encoding data.

### SUMMARY OF THE INVENTION

Accordingly, the present invention has as one object to provide a motion vector detection apparatus and method that enable detection of motion vectors of even images with much inter-frame motion.

Another object of the invention is to provide a motion-compensated encoding apparatus and method that enable encoding at a high rate of compression even in the case of images having much motion between frames.

According to an aspect of the present invention, there is provided a motion vector detection apparatus that detects individual motion vectors for each individual macro block of a plurality of macro blocks composing a current image by searching a search area set by a reference image, the motion vector detection apparatus comprising: a global vector determination unit configured to obtain a global vector that is a motion vector of the entire current image and the entire reference image; a reliability evaluation unit configured to evaluate the reliability of the global vector; a search area determination unit configured to determine the search area according to results of an evaluation of the reliability of the global vector; and a motion vector search unit configured to search a macro block of the current image inside a search area set by the reference image and detect a motion vector corresponding to the macro block.

According to another aspect of the present invention, there is provided a motion vector detection method that detects individual motion vectors for each individual macro block of a plurality of macro blocks composing a current image by searching a search area set by a reference image, the motion vector detection method comprising: a global vector determination step of obtaining a global vector that is a motion vector of the entire current image and the entire reference image; a reliability evaluation step of evaluating the reliability of the global vector; a search area determination step of determining the search area according to results of an evaluation of the reliability of the global vector; and a motion vector search step of searching a macro block of the current image inside a search area set by the reference image and detecting a motion vector corresponding to the macro block.

According to another aspect of the present invention, there is provided a computer program for causing a computer device to function as the motion vector detection apparatus according to the present invention and a computer-readable storage medium on which the program is recorded.

With such a configuration, the motion vector detection apparatus of the present invention can detect motion vectors even where there is much motion.

Other objects and advantages besides those discussed above shall be apparent to those skilled in the art from the description of a preferred embodiment of the invention which follows. In the description, reference is made to the accompanying drawings, which form a part thereof, and which illustrate an example of the various embodiments of the invention. Such example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an exemplary configuration of a motion vector detection apparatus according to a first embodiment of the present invention;

FIG. 2 is a block diagram showing an exemplary configuration of a conventional motion vector detection apparatus;

FIG. 3 is a block diagram showing another exemplary configuration of a conventional motion vector detection apparatus;

FIG. 4 is a block diagram showing an exemplary configuration of a motion vector detection apparatus according to a second embodiment of the invention;

FIG. 5 is a diagram illustrating a global vector selection method according to one embodiment;

FIG. 6 is a diagram illustrating a method of determining the reliability of the global vector according to a first embodiment;

FIG. 7 is a diagram illustrating a method of determining a search window position depending on the reliability of the global vector according to the first embodiment;

FIG. 8 is a diagram illustrating a method of determining a search window range depending on the reliability of the global vector according to a second embodiment;

FIG. 9 is a flow chart illustrating the operation of the motion vector detection apparatus according to the first embodiment of the invention; and

FIG. 10 is a flow chart illustrating the operation of the motion vector detection apparatus according to the second embodiment of the invention.

### DETAILED DESCRIPTION OF THE PREFERED EMBODIMENTS

Preferred embodiments of the present invention will now be described in detail in accordance with the accompanying drawings.

### First Embodiment

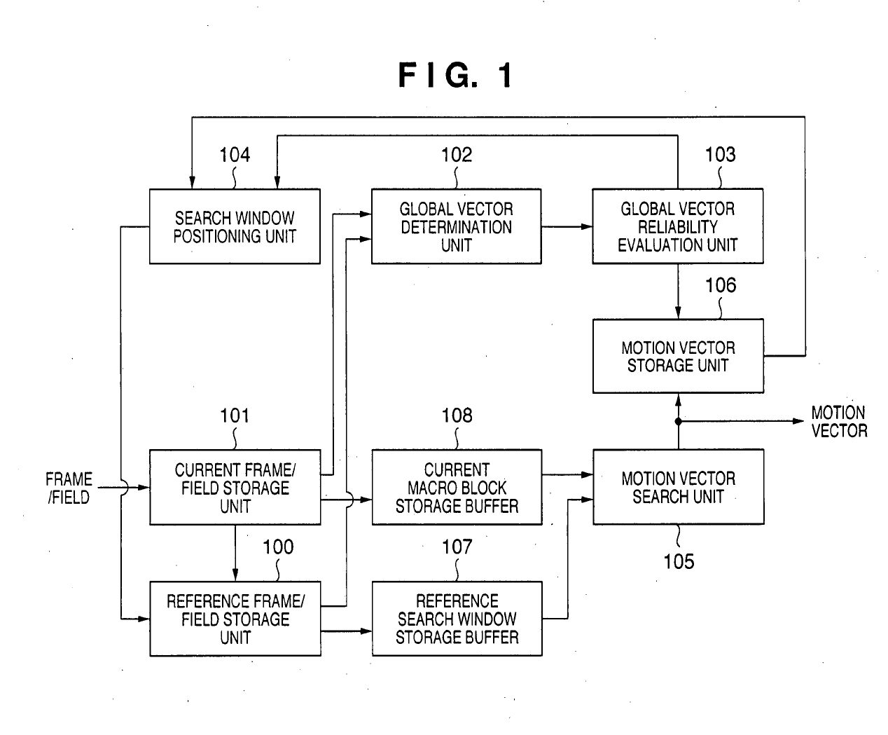

FIG. 1 is a block diagram showing an exemplary configuration of a motion vector detection apparatus according to a first embodiment of the present invention.

The motion vector detection apparatus of the present embodiment is comprised of a reference frame/field storage unit 100, a current frame/field storage unit 101, a global vector determination unit 102, a global vector reliability evaluation unit 103, a search window positioning unit 104, a motion vector search unit 105, a motion vector storage unit 106, a reference search window storage buffer 107 and a current macro block storage buffer 108.

In such a structure, the reference frame/field (reference image) for motion vector detection/estimation and the current frame/field (current image) are stored in the reference frame/field storage unit 100 and the current frame/field storage unit 101, respectively.

The global vector determination unit 102 uses all the pixel values of the reference frame/field and all the pixel values of the current frame/field provided from the reference frame/field storage unit 100 and the current frame/field storage unit 101 to determine a global vector showing the difference in spatial position between the current frame/field and the reference frame/field.

The global vector reliability evaluation unit 103 evaluates the reliability of the global vector determined by the global vector determination unit 102. The search window positioning unit 104 from the global vector or the preceding local motion vector from the search window.

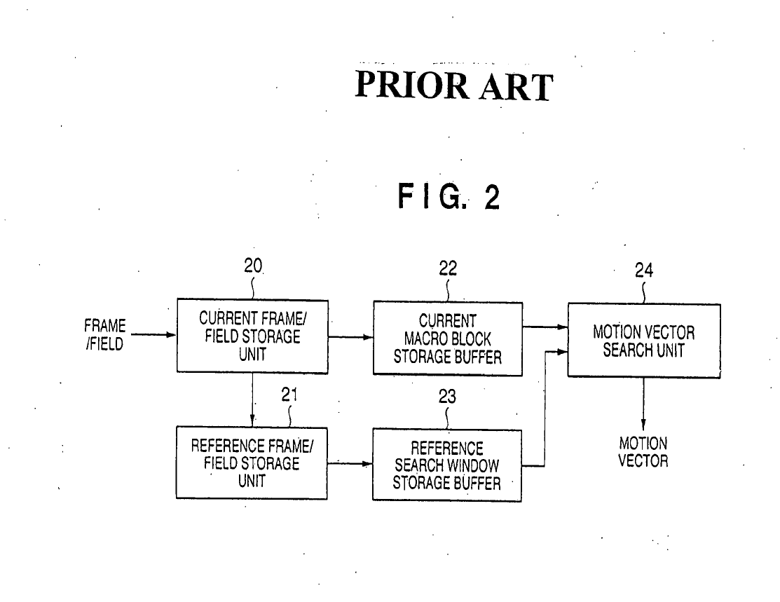

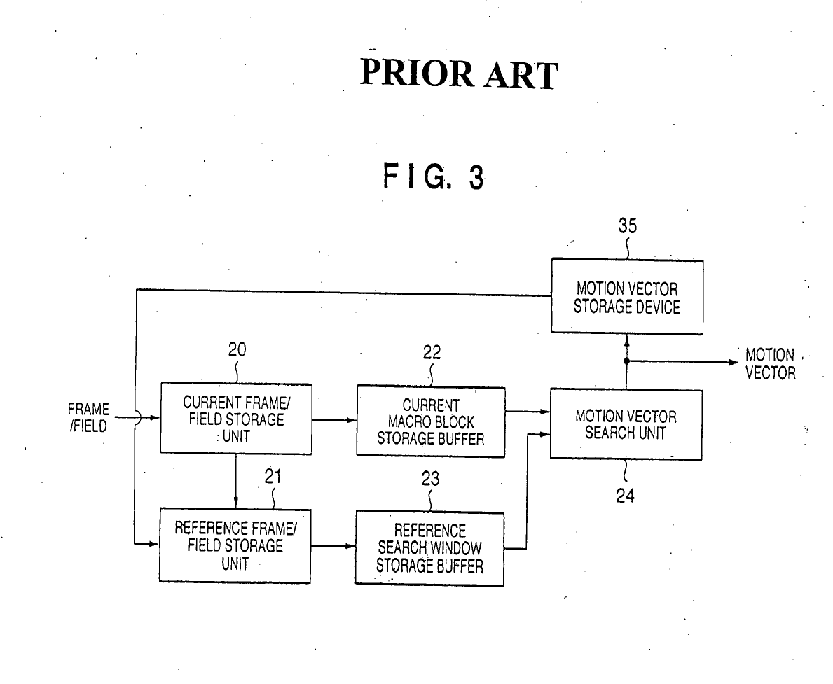

The motion vector search unit 105 and the motion vector storage unit 106, as well as the reference search window storage buffer 107 and the current macro block storage buffer 108 may have the same structural elements as those described in FIG. 2 and FIG. 3, and thus a description thereof is omitted.

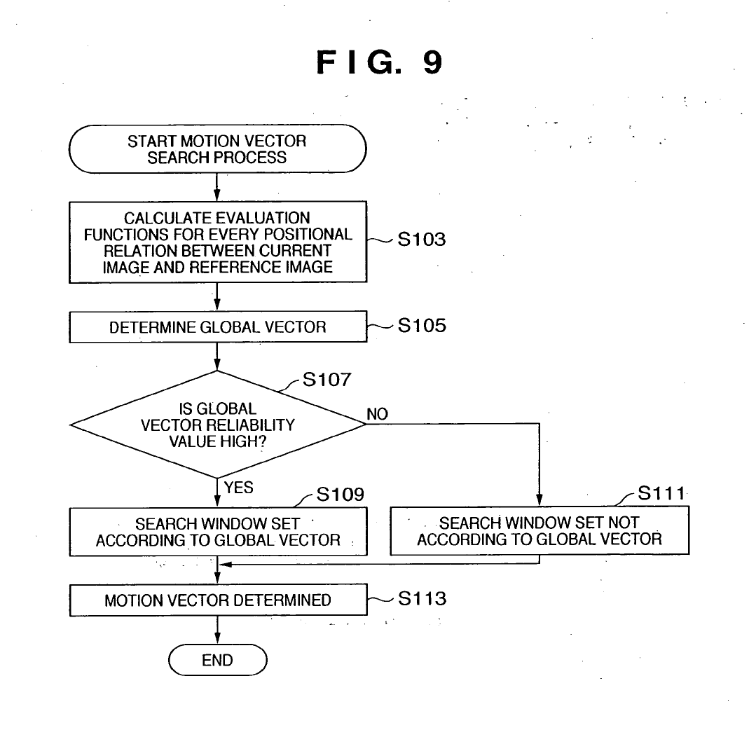

The operation of the motion vector detection apparatus of the foregoing embodiment will now be described using the flow chart shown in FIG. 9.

First, the global vector determination unit 102, in order to detect the global vector that is the motion vector of the reference frame/field (reference image) and the current frame/field (current image) (step S103), calculates evaluation functions for every positional relation between these images.

Such evaluation functions as MSE (Mean Square Error) (formula (1)), MAE (Mean Absolute Error) (formula (2)) or MAD (mean Absolute Difference) can be used to estimate the global vector that expresses the movement distance and direction having the maximum correlation between the reference frame/field and the current frame/field.

$$\begin{matrix}MSE ( i , j ) = \frac{1}{QR} {\sum }_{q = 0}^{Q} {\sum }_{r = 0}^{R} {[ {S}_{cur} ( m + i , n + j ) - {S}_{ref} ( m , n ) ]}^{2} \\ GRV = min MSE ( i , j ) ( - M \leq i \leq M , - N \leq j \leq N ) & ( 1 ) \\ MAE ( i , j ) = \frac{1}{QR} {\sum }_{q = 0}^{Q} {\sum }_{r = 0}^{R} \vert {S}_{cur} ( m + i , n + j ) - {S}_{ref} ( m , n ) \vert \\ GRV = min MAE ( i , j ) ( - M \leq i \leq M , - N \leq j \leq N ) & ( 2 )\end{matrix}$$

Here, S_{cur}(m,n) indicates the (m,n)^{th} pixel value in the current frame/field and S_{ref}(m,n) indicates the (m,n)^{th} pixel value in the reference frame/field. In addition, (i,j) indicates the respective spatial relations of the current frame/fields with respect to the reference frame/field.

(However, if M,N designate the number of horizontal and vertical pixels in one frame/field, then m=k×q, n=1×r, and k,1 is a natural number satisfying the conditions 0≦m≦M, 1≦k≦M, 0≦n≦N, 1≦1≦N. In addition, Q,R satisfy the conditions M−k≦Q≦M, N−1≦R≦N.

The evaluation functions are based on differences in the number of pixels, and the global vectors with the smallest MAE or MSE values selected.

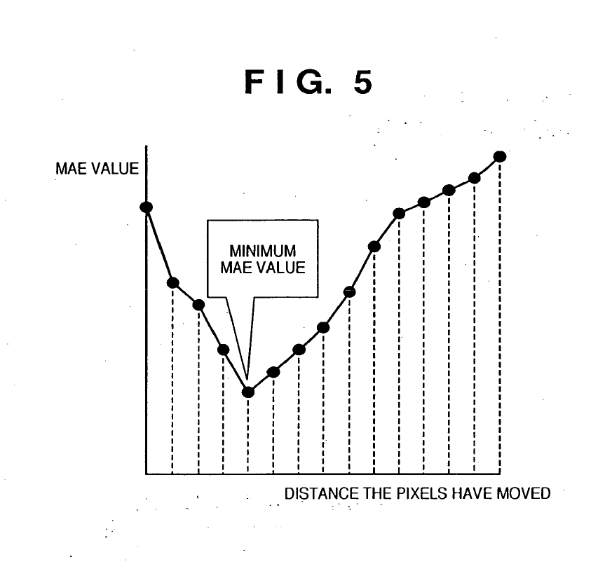

An example of a global vector selection method, in a case in which the MAE value is used as an example, is shown in FIG. 5. The reference frame is moved, in a predetermined direction, one pixel at a time and the average of the sum of all the MAE values is taken at each distance the pixels move. Then, the extent of movement when the average MAE value is smallest is taken as the global vector selection criterion. This process can, for example, also be conducted in another direction perpendicular to the predetermined direction, and if the extent of movement where the average MAE is smallest in this direction is obtained, the global vector can be determined from the two extents of movement and directions of movement.

In addition, the smallest MAE values and MSE values at this time are used as a global vector reliable value GRV (Global vector Reliable Value) by the global vector reliability evaluation unit 103. After the global vector determination unit 102 calculates the foregoing evaluation function as described above, it establishes the motion vector to the position showing the greatest degree of correlation as the global vector and transmits the global vector reliable value (GRV) as well as the global vector to the global vector reliability evaluation unit 103 (step S105).

(Global Vector Reliability Evaluation Method)

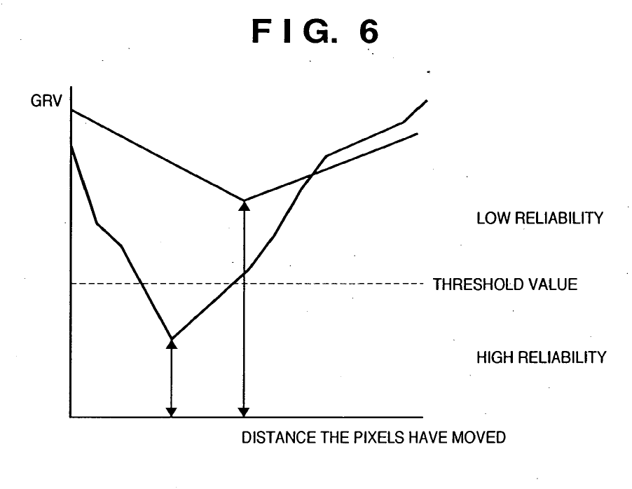

Next, the global vector reliability evaluation unit 103 evaluates the reliability of the global vector selected by the global vector determination unit 102 (step S107). An example of this evaluation method is shown in FIG. 6.

In this embodiment, the global vector reliability evaluation unit 103 compares the global vector reliable value GRV transmitted from the global vector determination unit 102 and a preset threshold value and decides that the reliability is high if the value of the global vector reliable value GRV is equal to or less than the threshold value. At this time, because the global vector is used in the positioning of the search window, the global vector reliability evaluation unit 103 transmits the global vector to the search window positioning unit 104.

By contrast, if the global vector reliable value GRV is greater than the threshold value, the global vector reliability evaluation unit 103 decides that the reliability of the global vector is low. In this case, the preceding local motion vector from the motion vector storage unit 106 is transmitted to the search window positioning unit 104 in place of the global vector. It should be noted that, in this case, it is also possible to transmit a zero motion vector indicating that there is no movement instead of the preceding local motion vector. In addition, any motion vector definable by a user may be transmitted instead of the preceding local motion vector.

The search window positioning unit 104 determines the position of the search window according to the transmitted motion vector (global vector) (step S109) or the preceding local motion vector (step S111). In other words, the search window positioning unit 104 sets the center of the search window at a position offset from the reference frame/field macro block corresponding to the current frame/field macro block by an amount equivalent to the motion vector. The reference frame/field storage unit 100 picks out an image of the required range in accordance with the center of the search window determined by the search window positioning unit 104 and transmits it to the search window storage buffer 107.

In addition, simultaneously, the current frame/field storage unit 101 picks out the current macro block image and transmits it to the current macro block storage buffer 108.

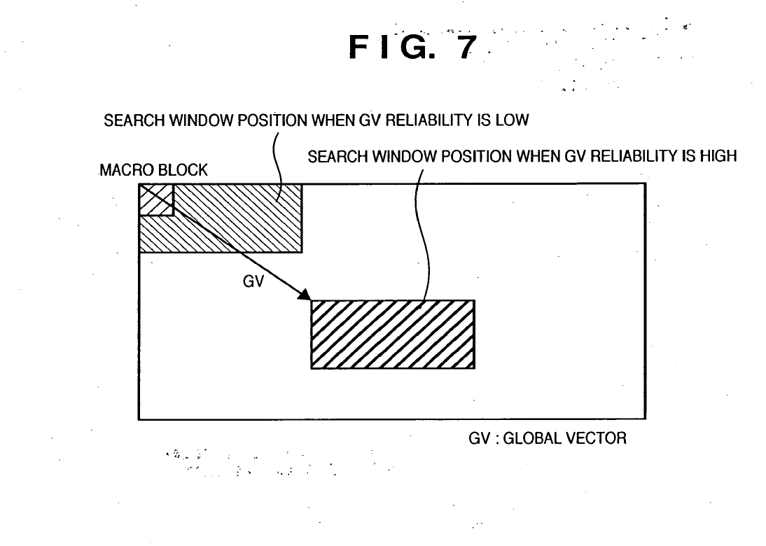

Thus, when the reliability of the global vector is high, the search window positioning unit 104 positions the search window so as to allow a search of the vicinity of the position designated by the global vector, and when the reliability is low, the search window positioning unit 104 positions the search window so as to allow a search of the vicinity of the macro block, as shown schematically in FIG. 7.

(Motion Vector Search)

Next, the motion vector search unit 105 searches an area in the search window that resembles the macro block and detects/estimates the motion vector corresponding to the current macro block (step S113). The estimated motion vector is output externally as well as transmitted to the motion vector storage unit 106 and used in motion vector estimation of the next macro block if the global vector reliability is low.

Here, when a search is made for the motion vector of a macro block of NXN size in a range ±p pixels in the reference frame/field, the size of the search window is (N+2p)×(N+2p). After calculating the above-described evaluation functions at all positions capable of becoming candidates for motion vectors, the vector to the position showing the greatest degree of correlation is established as the motion vector.

The estimation of the motion vector having the greatest degree of correlation can be obtained in the following manner using the MSE (Mean Square Error) (formula (3)), MAE (Mean Absolute Error) (formula (4)) or MAD (Mean Absolute Difference).

$$\begin{matrix}MSE ( i , j , k ) = \frac{1}{UV} {\sum }_{u = 0}^{U} {\sum }_{v = 0}^{V} {[ {S}_{cur , k} ( x , y ) - {S}_{ref} ( x + i , y + j ) ]}^{2} \\ LRV ( k ) = min MSE ( i , j , k ) ( - X \leq i \leq X , - Y \leq j \leq Y ) & ( 3 ) \\ MAE ( i , j , k ) = \frac{1}{UV} {\sum }_{u = 0}^{U} {\sum }_{v = 0}^{V} \vert {S}_{cur , k} ( x , y ) - {S}_{ref} ( x + i , y + j ) \vert \\ LRV = min MSE ( i , j , k ) ( - X \leq i \leq X , - Y \leq j \leq Y ) & ( 4 )\end{matrix}$$

Here, S_{ref} denotes the reference frame/field, S_{cur,k} denotes the current frame/field and k^{th} denotes macro block. In addition, (i,j) shows each of the spatial positions of the reference frame/field corresponding to the k^{th} macro block of the current frame/field.

(However, when X and Y denote the number of horizontal and vertical pixels of the search window, x=g×u, y=h×v, and g,h are natural numbers satisfying the conditions 0≦x≦X, 1≦g≦X, 0≦y≦Y, 1≦h≦Y. In addition, U,V satisfy the conditions X−g≦U≦X, Y−h≦V≦Y.)

The evaluation functions are based on differences in the pixel values, and the motion vector expressing the distance and direction of movement in the case of the smallest MAE or MSE values is selected as the final motion vector of the current macro block.

With such a structure, the present embodiment, by obtaining a global vector that is a motion vector of the entire current image and the entire reference image and using that global vector to set the reference search window, can detect motion vectors even for images having much motion compared to a case in which the current macro block is made the center of the reference search window or a case in which the reference search window is set using the preceding local motion vector. Accordingly, using the motion vector detection apparatus of this embodiment solves the problem of conventional motion-compensated encoding systems, in which the motion vector could not be detected in situations of much motion and intracoding was carried out resulting in an increase in encoding volume, and allows the motion-compensated compression encoding effect to be improved.

### Second Embodiment

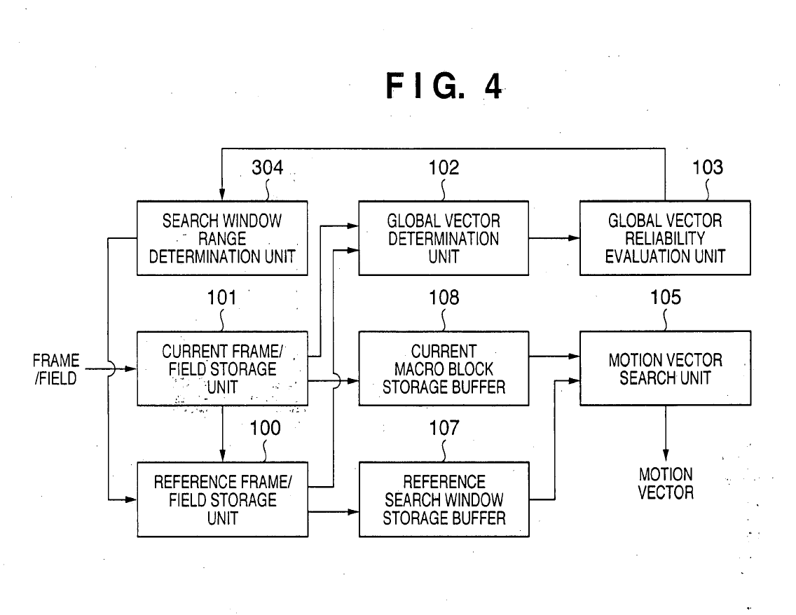

FIG. 4 is a block diagram showing an exemplary configuration of a motion vector detection apparatus according to a second embodiment of the invention. The motion vector detection apparatus according to the second embodiment has basically the same configuration as that of the first embodiment, except that the motion vector detection apparatus of the second embodiment has a search window range determination unit 304 in place of the search window positioning unit 104 and does not have the motion vector storage unit 106. Therefore, constituent elements shown in FIG. 4 that are the same as those shown in FIG. 1 are given the same reference numerals and redundant description thereof omitted.

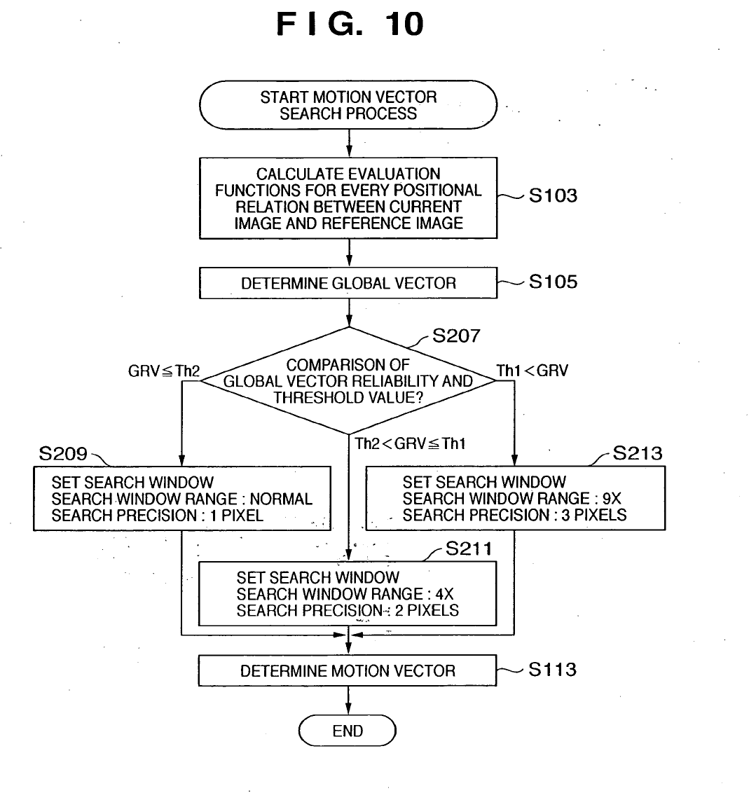

A description will now be given of the operation of the motion vector detection apparatus of the present embodiment, while referring also to the flow chart shown in FIG. 10.

First, processing up to and including the selection of the global vector (steps S103-S105) are the same as in the first embodiment.

In this embodiment, the reliability evaluation process conducted by the global vector reliability evaluation unit 103 in step S207 and the process of setting the search window setting depending on the results of that evaluation differ from those of the first embodiment.

Specifically, in step S207, when the global vector reliability evaluation unit 103 conducts the reliability evaluation, it uses a plurality of threshold values, and changes the search window range in stages depending on the relation between the reliable value GRV and the plurality of threshold values. In this embodiment, a description is given using an example in which the global vector reliability evaluation unit 103 uses two threshold values, Th1, Th2.

In this case, there are three possible forms that the relation between the global vector reliable value GRV and the threshold values Th1, Th2 can take, as follows:

GRV≦Th2 (i)

Th2<GRV≦Th1 (ii) (5)

Th1<GRV (iii)

The global vector reliability evaluation unit 103 evaluates reliability in the order (i), (ii), (iii), that is, determines that reliability is highest when the condition of (i) is satisfied, and sets the range of the search window and the search precision according to the results of that evaluation in stages (steps S209, S211, S213).

Specifically, in the case of (i), where reliability is highest, the search window is set at a normal size and the search precision is also set at the normal 1 pixel (or half pixel). In the case of (ii), the next highest reliability, because the reliability of the global vector has declined compared to (i), the search window is set larger than normal.

Simply making the search window range bigger means that sometimes the capacity of the reference search window storage buffer 107 will be insufficient, or that the length of time needed for searching will increase. Consequently, in the present embodiment, this problem is solved by decreasing the search precision at the same time as the search window range is expanded.

Specifically, the resolution of the reference images to be stored in the reference search window storage buffer 107 is halved in the horizontal and the vertical directions, enabling four times the normal range of reference images to be stored in the buffer 107. Conducting a search at every single pixel using this type of reference image is the same as conducting a search at every other pixel of a reference image at normal resolution, and is equivalent to decreasing the search precision to ¼ the normal level.

In addition, because the reliability of the global vector declines further in the case of (iii), the search range is broadened further than in (ii) (for example, the resolution of the reference images is set at ⅓ normal in the horizontal and vertical directions and the range is expanded to nine times normal). Conducting a search at every single pixel using this type of reference image is the same as conducting a search of every third pixel of a reference image of normal resolution, and is equivalent to decreasing the search precision to 1/9 the normal level.

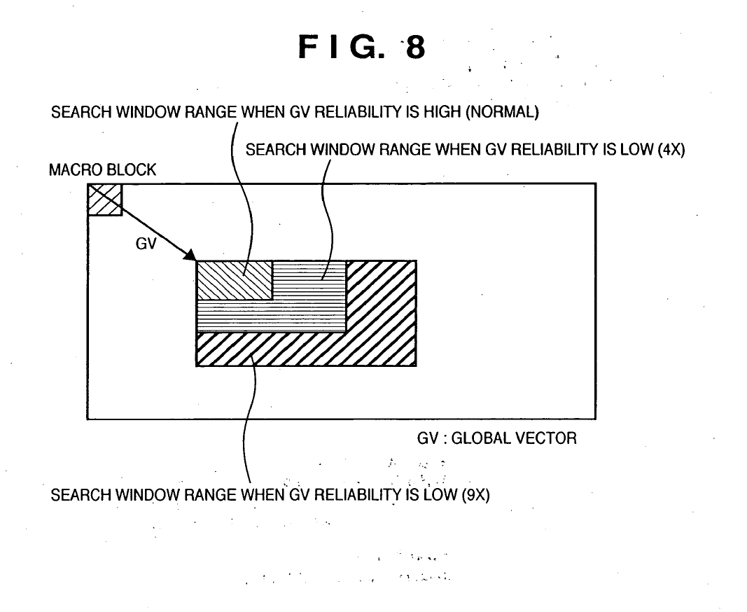

FIG. 8 shows schematically control of the search window range according to the reliability of the global vector in the present embodiment. As shown, in this embodiment, the global vector determines the search window reference position (in FIG. 8, the upper left coordinates) and the global vector reliability determines the size of the search window.

It should be noted that although in this embodiment the size of the search window in the case of (ii) is four times that in the case of (i), and the size in the case of (ii) is nine times that in (i), the magnification of the search window in the case of both (ii) and (iii) can of course be set to other values as well. For example, the horizontal resolution alone may be reduced to ½ or the like, so that the rate of decrease in the resolution is different from that in the vertical direction. In addition, although in this embodiment there are two threshold values used to evaluate reliability, the number of threshold values can be further increased, and the size of the search window can be further changed in stages.

The search window range determination unit 304 picks out the images necessary to each individual motion vector estimation from the reference frame/field storage unit 100 and the current frame/field storage unit 101 according to the global vector and the search window range transmitted from the global vector reliability evaluation unit 103 and transmits them to the reference search window storage buffer 107 and the current macro block storage buffer 108. At this time, the resolution of the images to be stored in the reference search window storage buffer 107 is decreased by thinning the pixels or the like depending on the size of the search window.

Then, the motion vector search unit 105, as described in the first embodiment, detects (step S113) and outputs the motion vector.

Although this embodiment uses the global vector and the global vector reliable value GRV to determines the position and the size of the search window, the position and size of the search window may also be determined using the smallest of the values obtained in formula 3 or formula 4 described above as the reliable value and using the local motion vector LRV and its reliable value (Local vector Reliable Value).

Thus, as described above, because it adjusts the size of the search window depending on the reliability of the global vector, the present embodiment enables the possibility of searching for and finding the local motion vector to be increased even when the global vector reliability is low. In addition, the local motion vector storage unit 106 is no longer needed, making it possible achieve a simpler configuration.

### Other Embodiments

The motion vector detection apparatus described in the foregoing embodiments can be suitably adapted to motion-compensated compression encoding devices, and as a result enables compression rates for images with much motion to be improved.

Although the foregoing embodiments have been described with reference to a motion vector detection apparatus composed of a single device, the present invention is not limited thereto and may be achieved by a system composed of a plurality of devices of similar functions.

Furthermore, the invention also includes a case in which the same functions as those of the present invention are achieved by supplying a software program that implements the functions of the foregoing embodiments directly or indirectly, or by using wire/wireless communications, to a system or apparatus having a computer capable of executing the program, with the computer of the system or apparatus then executing the program thus supplied.

Accordingly, since a computer implements the processing functions of the present invention, the program code supplied to and installed in the computer itself also achieves the present invention. In other words, the computer program for implementing the functional processes of the invention is itself also within the scope of the present invention.

In that case, so long as the system or apparatus has the functions of the program, the program may be executed in any form, such as an object code, a program executed by an interpreter, or scrip data supplied to an operating system.

Examples of storage media that can be used for supplying the program are magnetic storage media such as a floppy disk, a hard disk, or magnetic tape, optical/magneto-optical storage media such as an MO, a CD-ROM, a CD-R, a CD-RW, a DVD-ROM, a DVD-R, or a DVD-RW, and a non-volatile semiconductor memory or the like.

As for the method of supplying the program using wire/wireless communications, there is, for example, a method in which a data file (program data file), either a computer program itself that forms the invention or a file or the like that is compressed and automatically installed, and capable of becoming the computer program that comprises the invention on a client computer, is stored on a server on a computer network, and the program data file is downloaded to a connected client computer. In this case, the program data file may be divided into a plurality of segment files and the segment files distributed among different servers.

In other words, a server device that downloads, to multiple users, the program data files for implementing the functional processes of the present invention by computer, is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases in which the aforementioned functions according to the embodiments are implemented by a computer executing the read program, an operating system or the like running on the computer may perform all or a part of the actual processing based on the instructions of that program, so that the functions of the foregoing embodiments can be implemented by this processing.

Furthermore, after the program read from the storage medium is written to a function expansion board inserted in the computer or to a memory provided in a function expansion unit connected to the computer, a CPU or the like mounted on the function expansion board or function expansion unit may perform all or a part of the actual processing, so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-174604 filed on Jun. 11, 2004, which is hereby incorporated by reference herein.

What is claimed is:

1-11. (canceled)

12. A motion vector detection apparatus comprising:
first determination unit configured to determine a global vector which corresponds to a motion vector calculated from a target image and a reference image;
a reliability evaluation unit configured to determine whether or not a value corresponding to a reliability of the global vector is larger than a predetermined value;
a second determination unit configured to (a) determine a position of a first search area based on the global vector when the value corresponding to the reliability of the global vector is smaller than the predetermined value, and (b) determine a position of a second search area based on a predetermined motion vector when the value corresponding to the reliability of the global vector is larger than the predetermined value, wherein the target macro block corresponds to one of macro blocks included in the target image; and
search unit configured to (a) search the first search area set in the reference image to detect a motion vector of the target macro block when the value corresponding to the reliability of the global vector is smaller than the predetermined value, and (b) search the second search area set in the reference image to detect a motion vector of the target macro block when the value corresponding to the reliability of the global vector is larger than the predetermined value.

13. A method comprising:
determining a global vector which corresponds to a motion vector calculated from a target image and a reference image;
determining whether or not a value corresponding to a reliability of the global vector is larger than a predetermined value;
determining a position of a first search area based on the global vector when the value corresponding to the reliability of the global vector is smaller than the predetermined value;
determining a position of a second search area based on a predetermined motion vector when the value corresponding to the reliability of the global vector is larger than the predetermined value, wherein the target macro block corresponds to one of macro blocks included in the target image;
searching the first search area set in the reference image to detect a motion vector of the target macro block when the value corresponding to the reliability of the global vector is smaller than the predetermined value; and
searching the second search area set in the reference image to detect a motion vector of the target macro block when the value corresponding to the reliability of the global vector is larger than the predetermined value.

14. A non-transitory storage medium that stores a program for causing a computer to execute a method, the method comprising:
determining a global vector which corresponds to a motion vector calculated from a target image and a reference image;
determining whether or not a value corresponding to a reliability of the global vector is larger than a predetermined value;
determining a position of a first search area based on the global vector when the value corresponding to the reliability of the global vector is smaller than the predetermined value;
determining a position of a second search area based on a predetermined motion vector when the value corresponding to the reliability of the global vector is larger than the predetermined value, wherein the target macro block corresponds to one of macro blocks included in the target image;
searching the first search area set in the reference image to detect a motion vector of the target macro block when the value corresponding to the reliability of the global vector is smaller than the predetermined value; and
searching the second search area set in the reference image to detect a motion vector of the target macro block when the value corresponding to the reliability of the global vector is larger than the predetermined value.

15. The motion vector detection apparatus according to claim 12, wherein the second determination unit is configured to determine a position of the first search area based on the global vector when the value corresponding to the reliability of the global vector is equal to the predetermined value, and
the search unit is configured to search the first search area set in the reference image to detect a motion vector of the target macro block when the value corresponding to the reliability of the global vector is smaller than the predetermined value.

16. The motion vector detection apparatus according to claim 12, wherein the reliability evaluation unit is configured to evaluate that the reliability of the global vector is high when the value corresponding to the reliability of the global vector is smaller than the predetermined value, and
the reliability evaluation unit is configured to evaluate that the reliability of the global vector is low when the value corresponding to the reliability of the global vector is larger than the predetermined value.

17. The motion vector detection apparatus according to claim 16, wherein the reliability evaluation unit evaluates that the reliability of the global vector is high when the value corresponding to the reliability of the global vector is equal to the predetermined value.

18. The motion vector detection apparatus according to claim 12, wherein the predetermined motion vector corresponds to a motion vector of a preceding macro block which is detected before a motion vector of the target macro block is detected.

19. The motion vector detection apparatus according to claim 12, wherein the predetermined motion vector corresponds to a motion vector which indicates that there is no motion.

20. The motion vector detection apparatus according to claim 12, wherein the motion vector corresponding to the global vector is calculated by differences between pixels in the target image and pixels in the reference image.

21. The motion vector detection apparatus according to claim 12, wherein the motion vector corresponding to the global vector is calculated by an equation for calculating Mean Square Error (MSE).

22. The motion vector detection apparatus according to claim 12, wherein the motion vector corresponding to the global vector is calculated by an equation for calculating Mean Absolute Error (MAE).

23. The method according to claim 13, further comprising:
determining a position of the first search area based on the global vector when the value corresponding to the reliability of the global vector is equal to the predetermined value; and
searching the first search area set in the reference image to detect a motion vector of the target macro block when the value corresponding to the reliability of the global vector is smaller than the predetermined value.

24. The method according to claim 13, further comprising:
evaluating the reliability of the global vector is high when the value corresponding to the reliability of the global vector is smaller than the predetermined value; and
evaluating the reliability of the global vector is low when the value corresponding to the reliability of the global vector is larger than the predetermined value.

25. The method according to claim 24, further comprising
evaluating the reliability of the global vector is high when the value corresponding to the reliability of the global vector is equal to the predetermined value.

26. The method according to claim 13, wherein the predetermined motion vector corresponds to a motion vector of a preceding macro block which is detected before a motion vector of the target macro block is detected.

27. The method according to claim 13, wherein the predetermined motion vector corresponds to a motion vector which indicates that there is no motion.

28. The method according to claim 13, wherein the motion vector corresponding to the global vector is calculated by differences between pixels in the target image and pixels in the reference image.

29. The method according to claim 13, wherein the motion vector corresponding to the global vector is calculated by an equation for calculating Mean Square Error (MSE).

30. The method according to claim 13, wherein the motion vector corresponding to the global vector is calculated by an equation for calculating Mean Absolute Error (MAE).
